(19) United States
(12) Patent Application Publication
(10) Pub. No.: US 2019/0068335 A1
(43) Pub. Date: Feb. 28, 2019

(54) GRANT-FREE UPLINK COMMUNICATION

(71) Applicant: QUALCOMM Incorporated, San Diego, CA (US)

(72) Inventors: Chong LI, Weehawken, NJ (US); Jing JIANG, San Diego, CA (US)

(21) Appl. No.: 16/110,914

(22) Filed: Aug. 23, 2018

Related U.S. Application Data
(60) Provisional application No. 62/550,302, filed on Aug. 25, 2017.

(51) Int. Cl. H04L 5/00; H04W 72/12; H04W 72/04; H04W 72/08; H04L 1/00

(52) U.S. Cl. CPC H04L 5/005; H04W 72/1289; H04W 72/042; H04L 1/1812; H04W 72/1268; H04W 72/085; H04L 1/0003; H04W 72/0446

(57) ABSTRACT

Methods, systems, and devices for grant-free uplink communication are disclosed in which selection of a grant-free transmission format for data channel transmission may be based on link conditions. In some aspects, a user equipment identifies data for the grant-free uplink transmission, selects a grant-free transmission format from among a plurality of preconfigured grant-free transmission formats, and sends the data to a base station on the data channel using the selected grant-free transmission format. In some aspects the base station may receive channel state information from the UE and may assign a grant-free transmission format to the UE based at least in part on the channel state information. In some aspects, the base station may detect a grant-free uplink transmission on an uplink data channel, identify the UE based on a demodulation reference signal, and identify the format based on a grant-free format indicator.

### CROSS REFERENCES

The present Application for Patent claims the benefit of U.S. Provisional Patent Application No. 62/550,302 by LI, et al., entitled “GRANT-FREE UPLINK COMMUNICATION,” filed Aug. 25, 2017, assigned to the assignee hereof, and expressly incorporated herein.

### BACKGROUND

The following relates generally to wireless communications, and more specifically to low-latency uplink data transmission.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as a Long Term Evolution (LTE) systems or LTE-Advanced (LTE-A) systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform-spread-OFDM (DFT-S-OFDM). A wireless multiple-access communications system may include a number of base stations or network access nodes, each simultaneously supporting communication for multiple communication devices, which may be otherwise known as user equipment (UE).

The UE may transmit data to a base station in an uplink direction and receive data from the base station in a downlink direction. In some wireless communication systems, the UE accesses the uplink in accordance with scheduling performed by the base station. The UE may be notified of its opportunity to transmit by receiving an uplink grant. Due to the sporadic nature of uplink transmissions, the UE may first be required to request a grant from its serving base station and then wait to receive it before accessing the uplink. This handshaking for access to uplink resources can take the form of a scheduling request (SR) procedure and may introduce delay that is not suitable for low latency and other high-priority communications.

### SUMMARY

The described techniques relate to improved methods, systems, devices, and/or apparatuses that support grant-free uplink communication which is based on channel conditions. In some aspects, channel conditions are determined by a user equipment. The user equipment may send one or more reports with channel state information to a base station and may be assigned a grant-free uplink transmission format by the base station based on an assessment of the channel conditions. The UE may utilize its assigned format to send a grant-free uplink data transmission to the base station. In some aspects, the UE may determine channel conditions and may autonomously select a grant-free uplink transmission format from among a plurality of preconfigured formats based on the channel conditions. The UE may then transmit on an uplink data channel in accordance with its selected grant-free uplink transmission format without first requesting access or being granted uplink resources. The base station may monitor the uplink data channel for grant-free transmissions and may identify the UE and the selected grant-free uplink transmission format. The base station may then process the uplink data and communicate with the UE based on a result of the processing.

A method of wireless communication is described. The method may include identifying data for a grant-free uplink transmission, selecting a grant-free transmission format from among a plurality of grant-free transmission formats, and sending the data to a base station on a data channel using the selected grant-free transmission format. The method may also include receiving an indication of an assigned grant-free transmission format from the base station, and selecting the grant-free transmission format may be based on the indication. The method may include determining channel conditions for a link between the UE and the base station, and selecting the grant-free transmission format by the UE may be based at least in part on the channel conditions.

An apparatus for wireless communication is described. The apparatus may include a memory and at least one processor coupled to the memory and configured to cause the apparatus to identify data for a grant-free uplink transmission, select a grant-free transmission format from among a plurality of grant-free transmission formats, and send the data to a base station on a data channel using the selected grant-free transmission format. The at least one processor may also be configured to receive an indication of an assigned grant-free transmission format from the base station and to select the grant-free transmission format based on the indication. The at least one processor may be configured to determine channel conditions for a link between the apparatus and the base station and to select the grant-free transmission format based at least in part on the channel conditions.

Another apparatus for wireless communication is described. The apparatus may include means for identifying data for a grant-free uplink transmission, means for selecting a grant-free transmission format from among a plurality of grant-free transmission formats, and means for sending the data using the selected grant-free transmission format on a data channel to a base station.

A non-transitory computer readable medium storing code for wireless communication is described. The code may include instructions executable by a processor to identify data for a grant-free uplink transmission, to select a grant-free transmission format from among a plurality of grant-free transmission formats, and to send the data to a base station on a data channel using the selected grant-free transmission format.

Another method of wireless communication is described. The method may include determining channel conditions for a link between a base station and a user equipment and assigning a grant-free transmission format to the user equipment based on the channel conditions. Determining the channel conditions may be based on one or more reports received from the user equipment, a distance of the user equipment from the base station, and/or a historical hybrid automatic repeat request (HARQ) performance of the user equipment.

An apparatus for wireless communication is described. The apparatus may include a memory and at least one processor coupled to the memory and configured to cause the apparatus to determine channel conditions for a link between the apparatus and a user equipment and assign a grant-free transmission format to the user equipment based on the channel conditions. In another aspect, the apparatus may include means for determining channel conditions for a link between the apparatus and a user equipment and means for assigning a grant-free transmission format to the UE based on the channel conditions.

A non-transitory computer readable medium storing code for wireless communication is described. The code may include instructions executable by a processor to determine channel conditions for a link with a user equipment and to assign a grant-free transmission format to the user equipment based on the channel conditions.

Another method of wireless communication is described. The method may include receiving a grant-free uplink data channel transmission from a user equipment, identifying the user equipment based at least in part on a demodulation reference signal accompanying the grant-free uplink data channel transmission, identifying a grant-free transmission format associated with the grant-free uplink data channel transmission, and processing the grant-free uplink data channel transmission based on identifying the user equipment and the grant-free transmission format.

Another apparatus for wireless communication is described. The apparatus may include a processor, memory in electronic communication with the processor, and instructions stored in the memory. The instructions may be executable by the processor to cause the apparatus to receive a grant-free uplink data channel transmission from a user equipment, identify the user equipment based at least in part on a demodulation reference signal accompanying the grant-free uplink data channel transmission, identify a grant-free transmission format associated with the grant-free uplink data channel transmission, process the grant-free uplink data channel transmission based on identifying the user equipment and the grant-free transmission format, and communicate with the user equipment based on a result of the processing. In another aspect, the apparatus includes means for performing each of the foregoing operations.

A non-transitory computer readable medium storing code for wireless communication is described. The code may include instructions executable by a processor to receive a grant-free uplink data channel transmission from a user equipment, identify the user equipment based at least in part on a demodulation reference signal accompanying the grant-free uplink data channel transmission, identify a grant-free transmission format associated with the grant-free uplink data channel transmission, process the grant-free uplink data channel transmission based on identifying the user equipment and the grant-free transmission format, and communicate with the UE based on a result of the processing.

### BRIEF DESCRIPTION OF THE DRAWINGS

FIG. 1 shows an exemplary a wireless communications system that supports grant-free uplink communication.

FIG. 2 shows a communications flow that illustrates aspects of grant-free uplink communication.

FIGS. 3A and 3B illustrate aspects of grant-free uplink transmission formats in accordance with the present disclosure

FIG. 4 shows a further communications flow that illustrates aspects of grant-free uplink communication.

FIG. 5 is a block diagram of a wireless device that supports grant-free uplink transmission in accordance with aspects of the present disclosure.

FIG. 6 is a block diagram of a wireless device that supports grant-free uplink transmission in accordance with aspects of the present disclosure.

FIG. 7 shows a diagram of a system including a device that supports grant-free uplink transmission in accordance with aspects of the present disclosure.

FIG. 8 is a block diagram of a wireless device that supports grant-free uplink communication in accordance with aspects of the present disclosure.

FIG. 9 shows a block diagram of a wireless device that supports grant-free uplink communication in accordance with aspects of the present disclosure

FIG. 10 shows a diagram of a system including a device that supports grant-free uplink communication in accordance with aspects of the present disclosure.

FIG. 11 illustrates a method for grant-free uplink communication in accordance with aspects of the present disclosure.

FIGS. 12A-12B illustrate methods for grant-free uplink communication in accordance with aspects of the present disclosure.

### DETAILED DESCRIPTION

In some wireless communication systems, a user equipment accesses an uplink data channel by making an access request, receiving an access grant, and sending an uplink transmission in accordance with granted resources. For example, in LTE systems, a UE with uplink data to send may transmit a scheduling request signal and a buffer status report as part of a request for uplink resources from its serving base station. Thereafter, the UE may monitor a downlink control channel for an uplink grant. If a grant is received, the UE can then determine the extent of its uplink resources and how much data it can send. If a grant is not received, the UE may need to repeat the process or take some other action.

To support low latency communication, such as the ultra-reliable low latency communication (URLLC) service being developed for 5G systems, it may be desirable to use a grant-free approach to accessing the data channel. With a grant-free approach, a UE can send uplink data without receiving a grant for each uplink transmission. In one approach to grant-free uplink communication, a base station pre-allocates resources for the UE. If traffic patterns are known or predictable, then pre-allocating resources may be useful. For example, LTE systems can utilize semi-persistent scheduling (SPS) to support voice services in which the rate of the voice packets and the size of the voice packets follow a predictable pattern. However, for unpredictable or bursty traffic, such a pre-allocation approach may be wasteful and can reduce the benefits of statistical multiplexing.

Another approach to grant-free uplink communication is to operate in a purely contention-based manner. A contention based system could more fully utilize the available bandwidth resource. However, the drawback of contention-based operation is that it may result in low reliability at high load when collisions occur. For example, if URLLC traffic from multiple UEs contends for system resources along with enhanced mobile broadband (eMBB) traffic, then the expected collisions may make it difficult to achieve stringent latency requirements.

The pre-allocation and the contention-based approaches to grant-free uplink communication both suffer from the possibility that the uplink transmission format may not be appropriate for channel conditions. For example, as described herein, a grant-free (also, “GF”) uplink transmission from a cell-edge user may need a different payload size, resource allocation, multiplexing level, modulation rate, etc. than a similar grant-free uplink transmission from a cell-center user. If the uplink transmission format is not properly selected or assigned, the probability of a base station missing the initial uplink transmission may increase. This, in turn, may lower the URLLC capacity of a system and increase the difficulty of achieving latency targets. In some aspects, the present disclosure provides techniques for grant-free uplink communication which can take into account link conditions and improve system operation through the use of a plurality of pre-configured grant-free transmission formats.

Aspects of the disclosure are initially described in the context of a wireless communications system. Aspects of the disclosure are further illustrated by and described with reference to apparatus diagrams, system diagrams, and flowcharts that relate to grant-free uplink communication.

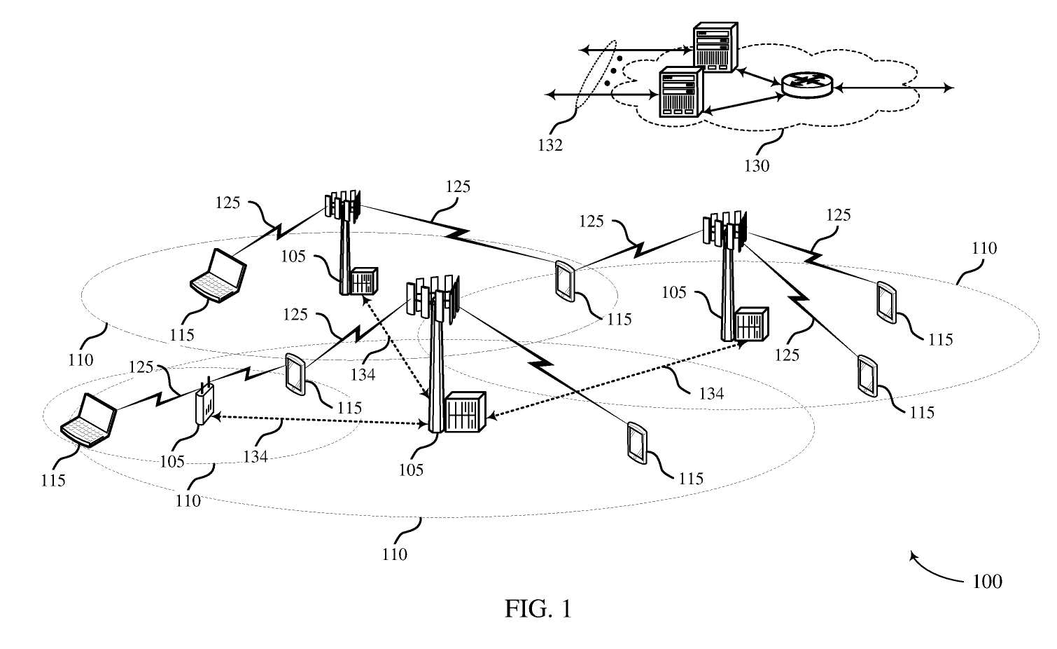

FIG. 1 illustrates an exemplary wireless communications system 100 that supports grant-free uplink communication in accordance with various aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, or a New Radio (NR) network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. Wireless communications system 100 may include base stations 105 of different types or power classes (e.g., macro or small cell base stations). The UEs 115 described herein may be able to communicate with the various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions, from a base station 105 to a UE 115. Downlink transmissions may also be called forward link transmissions while uplink transmissions may also be called reverse link transmissions.

The geographic coverage area 110 for a base station 105 may be divided into sectors making up only a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for UEs 115 include entering a power saving “sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1 or other interface). Base stations 105 may communicate with one another over backhaul links 134 (e.g., via an X2 (XN), or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be coupled to the P-GW. The P-GW may provide IP address allocation as well as other functions. The P-GW may be coupled to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 MHz to 300 GHz. Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that can tolerate interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115 (e.g., for multiple-input multiple-output (MIMO) operations such as spatial multiplexing, or for directional beamforming). However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed radio frequency spectrum bands. For example, wireless communications system 100 may employ LTE Licensed Assisted Access (LTE-LAA) or LTE-Unlicensed (LTE-U) radio access technology or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a carrier aggregation configuration in conjunction with component carriers operating in a licensed band. Operations in the unlicensed spectrum may include downlink transmissions, uplink transmissions, peer-to-peer transmissions, or a combination of these. Duplexing in the unlicensed spectrum may be based on frequency division duplexing (FDD), time division duplexing (TDD), or a combination of both.

In some cases, the antennas of a base station 105 or UE 115 may be located within one or more antenna arrays, which may support MIMO operations such as spatial multiplexing, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

MIMO wireless systems use a transmission scheme between a transmitting device (e.g., a base station 105) and a receiving device (e.g., a UE 115), where both transmitting device and the receiving device are equipped with multiple antennas. MIMO communications may employ multipath signal propagation to increase the utilization of a radio frequency spectrum band by transmitting or receiving different signals via different spatial paths, which may be referred to as spatial multiplexing. The different signals may, for example, be transmitted by the transmitting device via different antennas or different combinations of antennas. Likewise, the different signals may be received by the receiving device via different antennas or different combinations of antennas. Each of the different signals may be referred to as a separate spatial stream, and the different antennas or different combinations of antennas at a given device (e.g., the orthogonal resource of the device associated with the spatial dimension) may be referred to as spatial layers.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a direction between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain phase offset, timing advance/delay, or amplitude adjustment to signals carried via each of the antenna elements associated with the device. The adjustments associated with each of the antenna elements may be defined by a beamforming weight set and may be associated with a particular orientation (e.g., with respect to the antenna array of the transmitting device or receiving device, or with respect to some other orientation).

In one example, a base station 105 may multiple use antennas or antenna arrays to conduct beamforming operations for directional communications with a UE 115. For instance, signals may be transmitted multiple times in different directions, which may include a signal being transmitted according to different beamforming weight sets associated with different directions of transmission. A receiving device (e.g., a UE 115, which may be an example of a mmW receiving device) may try multiple receive beams when receiving various signals from the base station 105, such as synchronization signals or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions.

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may in some cases perform packet segmentation and reassembly to communicate over logical channels. A Medium Access Control (MAC) layer may perform priority handling and multiplexing of logical channels into transport channels. The MAC layer may also use hybrid automatic repeat request (HARQ) to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical (PHY) layer, transport channels may be mapped to physical channels.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Ts=1/30,720,000 seconds. Time intervals of a communications resource may be organized according to radio frames each having a duration of 10 milliseconds (Tf=307200*Ts). The radio frames may be identified by a system frame number (SFN) ranging from 0 to 1023. Each frame may include ten subframes numbered from 0 to 9, and each subframe may have a duration of 1 millisecond. A subframe may be further divided into two slots each having a duration of 0.5 milliseconds, and each slot may contain 6 or 7 modulation symbol periods (e.g., depending on the length of the cyclic prefix prepended to each symbol period). Excluding the cyclic prefix, each symbol period may contain 2048 sampling periods. In some cases a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols and in some instances, a symbol of a mini-slot or a mini-slot may be the smallest unit of scheduling. Each symbol may vary in duration depending on the subcarrier spacing or frequency band of operation, for example. Some wireless communications systems may implement slot aggregation in which multiple slots or mini-slots may be aggregated together for communication between a UE 115 and a base station 105.

A resource element may consist of one symbol period (e.g., a duration of one modulation symbol) and one subcarrier (e.g., a 15 kHz frequency range). A resource block may contain 12 consecutive subcarriers in the frequency domain and, for a normal cyclic prefix in each orthogonal frequency-division multiplexing (OFDM) symbol, 7 consecutive OFDM symbol periods in the time domain (1 slot), or 84 total resource elements across the frequency and time domains. The number of bits carried by each resource element may depend on the modulation scheme (the configuration of modulation symbols that may be applied during each symbol period). Thus, the more resource elements that a UE 115 receives and the higher the modulation rate (e.g., the higher the number of bits that may be represented by a modulation symbol according to a given modulation scheme), the higher the data rate may be for the UE 115. In MIMO systems, a wireless communications resource may refer to a combination of a radio frequency spectrum band resource, a time resource, and a spatial resource (e.g., spatial layers), and the use of multiple spatial layers may further increase the data rate for communications with a UE 115.

The term “carrier” refers to a set of radio frequency spectrum resources having a defined organizational structure for supporting uplink or downlink communications over a communication link 125. For example, a carrier of a communication link 125 may include a portion of a radio frequency spectrum band that may also be referred to as a frequency channel. In some examples a carrier may be made up of multiple sub-carriers (e.g., waveform signals of multiple different frequencies). A carrier may be organized to include multiple physical channels, where each physical channel may carry user data, control information, or other signaling.

The organizational structure of the carriers may be different for different radio access technologies (e.g., LTE, LTE-A, NR, etc.). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, or 20 MHz). In some examples the system bandwidth may refer to a minimum bandwidth unit for scheduling communications between a base station 105 and a UE 115. In other examples a base station 105 or a UE 115 may also support communications over carriers having a smaller bandwidth than the system bandwidth.

Devices of the wireless communications system 100 (e.g., base stations or UEs 115) may have a hardware configuration that supports communications over a particular carrier bandwidth, or may be configurable to support communications over one of a set of carrier bandwidths. For example, base stations 105 or UEs 115 may perform some communications according to a system bandwidth (e.g., wideband communications), and may perform some communications according to a smaller bandwidth (e.g., narrowband communications). In some examples, the wireless communications system 100 may include base stations 105 and/or UEs that can support simultaneous communications via carriers associated with more than one different bandwidth.

Wireless communications system 100 may support communication with a UE 115 on multiple cells or carriers, a feature which may be referred to as carrier aggregation (CA) or multi-carrier operation. A UE 115 may be configured with multiple downlink CCs and one or more uplink CCs according to a carrier aggregation configuration. Carrier aggregation may be used with both FDD and TDD component carriers.

In some cases, wireless communications system 100 may utilize enhanced component carriers (eCCs). An eCC may be characterized by one or more features including wider carrier or frequency channel bandwidth, shorter symbol duration, shorter TTI duration, or modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In some cases, an eCC may utilize a different symbol duration than other CCs, which may include use of a reduced symbol duration as compared with symbol durations of the other CCs. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may consist of one or multiple symbol periods. In some cases, the TTI duration (that is, the number of symbol periods in a TTI) may be variable.

Wireless communications systems such as an NR system may use a combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across frequency) and horizontal (e.g., across time) sharing of resources.

Base stations 105 may support grant-free uplink transmission by UEs 115 in their respective coverage areas. In some examples, a base station 105 may assign to a UE 115 a grant-free uplink transmission format (also referred to as a “grant-free transmission format,” or a “GF format” for brevity) in a semi-static manner, such as with a dedicated configuration message. Or, the base station 105 may indicate the grant-free transmission format dynamically such as through downlink control information or other control channel signaling. The assigned GF transmission format may be based upon conditions for a link between the base station 105 and the user equipment 115 such as may be indicated by channel feedback, measurement reports, historic HARQ performance, a current/projected location of the UE in a cell, and combinations thereof. The UE 115 may utilize its assigned GF transmission format for uplink transmission on a data channel (e.g., on a physical uplink shared channel (PUSCH)) thereby avoiding the latency which may be associated with grant-based uplink communication. In some examples, the UE 115 may select a grant-free transmission format from among a plurality of pre-defined or preconfigured GF transmission formats for use in data channel communication. The UE 115 may select the GF transmission format based on current channel conditions; in this way, the UE 115 may be able to respond quickly to rapid changes in its RF environment. When the UE 115 operates to select the GF transmission format, it may also provide an indication of the selected format to base station 105. The GF format indication may be explicitly or implicitly signaled to the base station 105 and may help reduce the burden associated with detecting grant-free transmissions.

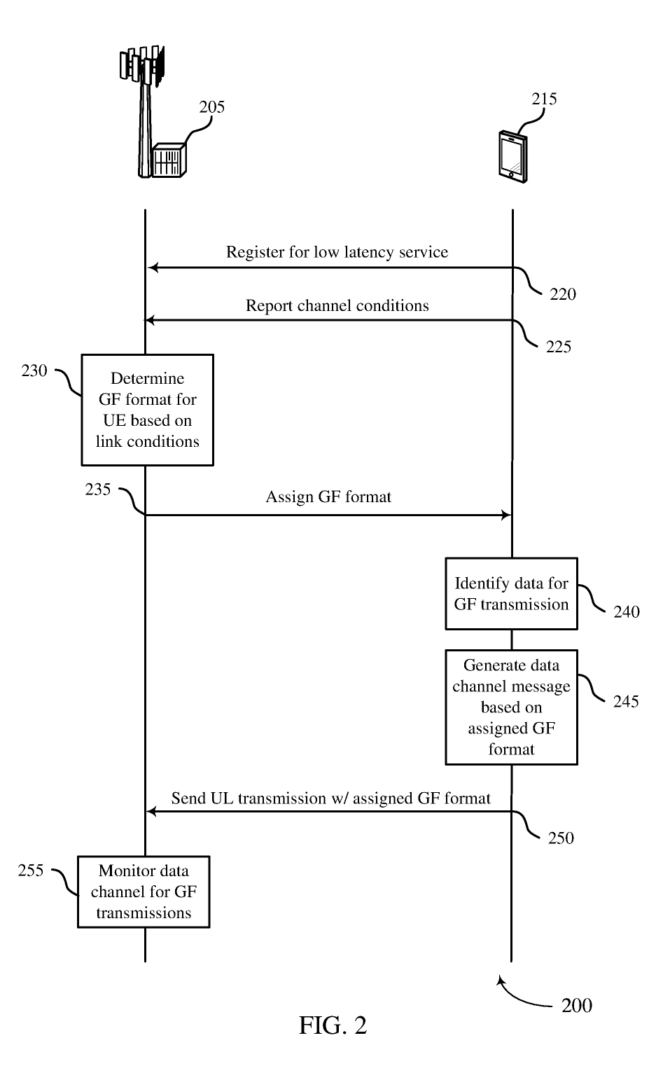

FIG. 2 shows an example of a communications flow 200 in a wireless communication system that supports grant-free uplink communication in accordance with various aspects of the present disclosure. In some examples, aspects of communications flow 200 may be implemented in wireless communication system 100.

Communications flow 200 illustrates an interaction between a UE 215 and a base station 205 in support of GF transmission on an uplink data channel. UE 215 may be an example of aspects of UE 115 as described with reference to FIG. 1. Base station 205 may be an example of aspects of base station 105 as described with reference to FIG. 1.

As shown, UE 215 may register for low latency service 220 with base station 205. The low latency service may include an ultra-reliable low latency communication (URLLC) service for which certain latency and reliability requirements have been defined. The registering may include reporting a capability of UE 215 to support URLLC communication and/or making a request by UE 215 to begin utilizing URLLC services.

At 225, UE 215 reports channel conditions to base station 205. This may include sending one or more reports to base station 205. The one or more reports may include channel state information (CSI), interference metrics, and other indicators of the quality of uplink communications with base station 205. In some examples, the one or more reports may include serving cell measurements and/or measurements of neighbor cells. Examples include SINR (signal-to-interference-plus-noise ratio), C/I (carrier-to-interference ratio), RSRP (reference signal received power), RSRQ (reference signal received quality), and the like. In some cases, the UE 215 may also report its current or projected location in a cell as an additional factor for use by base station 205 in determining channel conditions. Additionally, the UE may send measurement reports or other indications of neighbor cell signals and/or the occurrence of events associated with changing channel conditions.

Base station 205 may determine a grant-free uplink transmission format at 230 based on the channel conditions. For example, base station 205 may identify a grant-free uplink transmission format for UE 215 based on the reported channel state information, interference measurements, location, historic HARQ performance, and/or information relating to other UEs by which link conditions may be characterized. The GF uplink transmission format may be one of a plurality of GF uplink transmission formats that are pre-configured for UE 215. For example, the UE 215 may be provisioned with a plurality of GF uplink transmission formats, or it may be configured with a UE-specific set of GF uplink transmission formats for use in communicating with base station 205.

Each GF uplink transmission format may define a payload size for uplink transmission, a resource allocation for uplink transmission, a multiplexing level for uplink transmission, or a modulation rate for uplink transmission, or any combination thereof. By having a plurality of GF uplink transmission formats from which to select, the base station 205 can choose a format that is best suited for the particular link conditions experienced by UE 215 and can vary its selection of formats as those link conditions change.

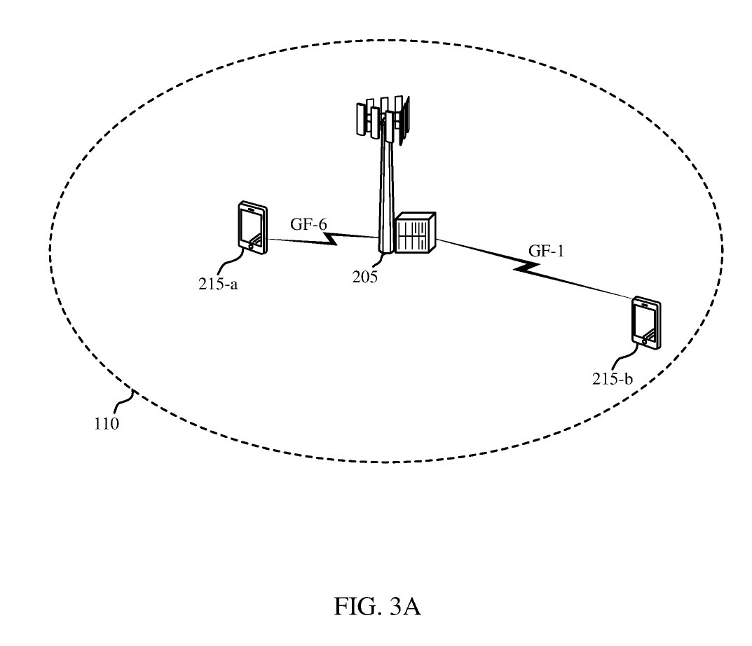

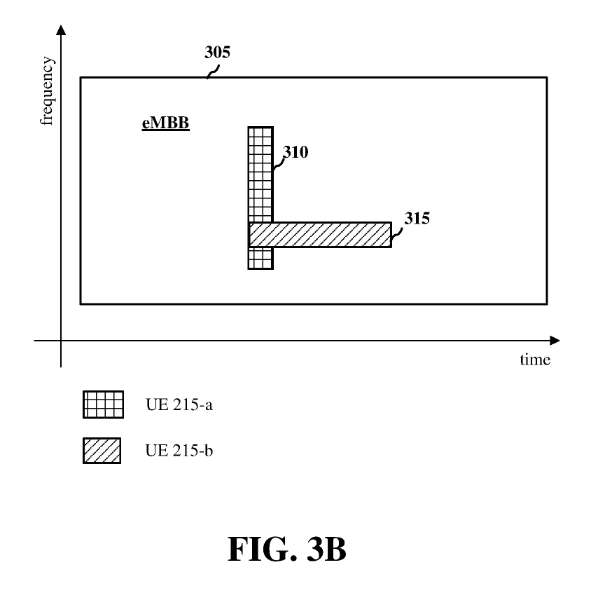

FIG. 3A illustrates aspects of grant-free uplink transmission formats in accordance with the present disclosure. In this example, two UEs 215-a, 215-b use different grant-free uplink transmission formats (GF-6, GF-1) to communicate with a base station 205. UE 215-a is shown as being located near base station 205 and may experience relatively good channel conditions. By contrast, UE 215-b is operating near the edge of coverage area 110 and may experience relatively poor channel conditions. It will be recognized that the terms “good,” “better,” “worse,” and “poor” as used herein to describe channel conditions may be understood in terms of one or more signal strength and/or interference-based thresholds such that, from the base station perspective, “good” channel conditions refers to the availability of a relatively strong uplink signal while “poor” channel conditions refers to the availability of a relatively weak uplink signal regardless of how corresponding signal strength and/or interference thresholds may be defined, or in whatever other way the channel conditions may be characterized.

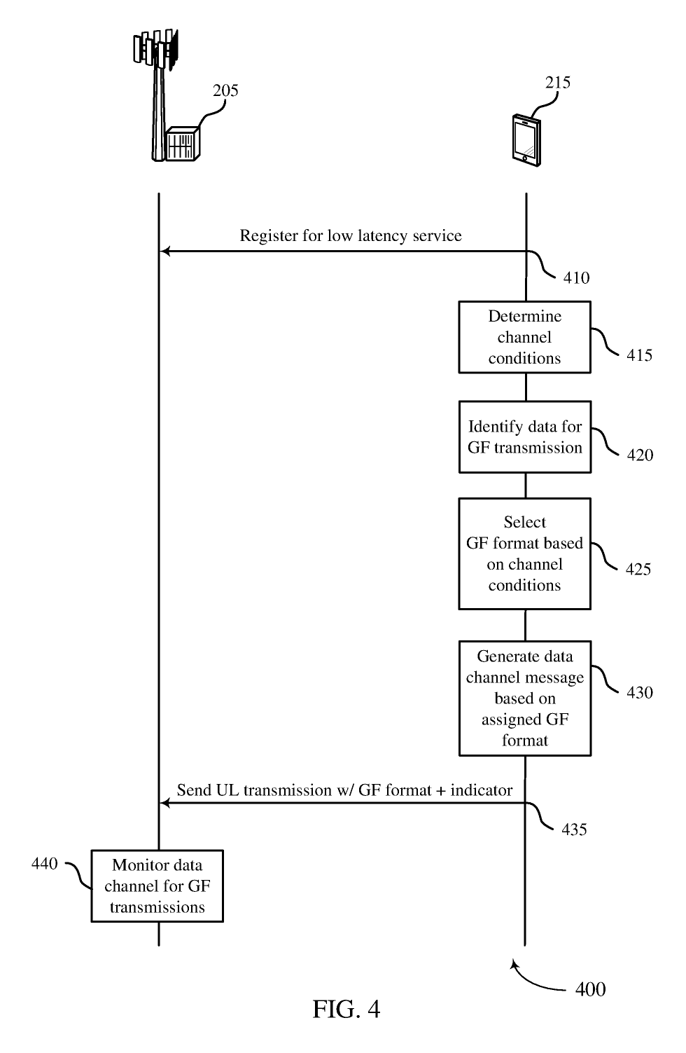

The grant-free uplink transmission format utilized for communication may be assigned by base station 205 (FIG. 2) or selected by the UEs 215 (FIG. 4). In each case, the selection of a grant-free uplink transmission format may be based on link conditions. As described above, each GF uplink transmission format may define (or correspond to) a payload size, a resource allocation pattern, a multiplexing level, and/or a modulation rate. A grant-free uplink transmission format can thus be selected so as to match particular attributes of the GF formats with what is needed to communicate in view of the prevailing or expected link conditions. For example, a grant-free uplink transmission format having a larger payload size may be used in better channel conditions, whereas a grant-free transmission format having a smaller payload size may be used in worse channel conditions. Thus, as shown in FIG. 3A, GF-6 utilized by cell-center UE 215-a may have a relatively large payload size in comparison with GF-1 utilized by cell-edge UE 215-b. In extremely poor channel conditions, GF-1 may represent an format which does not include a data payload, but instead includes only a demodulation reference signal (DMRS) which can identify UE 215-b in a manner that is similar to a scheduling request signal. In slightly better channel conditions, UE 215-b might use another GF format (e.g., GF-2) which can accommodate both the DMRS and, for example, a buffer status report. In still better channel conditions, UE 215-b might use yet another GF format (e.g., GF-3) with a larger data payload, and so on.

FIG. 3B illustrates additional aspects of grant-free uplink transmission formats in accordance with the present disclosure. Here, an uplink data channel 305 is shown. The uplink data channel 305 may be a physical uplink shared channel (PUSCH) which is utilized by multiple users and which can support different services. In this example, the full channel bandwidth is utilized for an enhanced mobile broadband service (eMBB) while separate grant-free uplink transmissions 310, 315 in the PUSCH are shown for UEs 215-a and UE 215-b, respectively.

Grant-free uplink transmissions 310, 315 may correspond to different grant-free uplink transmission formats. Grant-free uplink transmission 310 represents a relatively wide-band transmission in which multiple frequency elements are utilized perhaps in a same symbol (time) interval. By contrast, grant-free uplink transmission 315 represents a narrow-band transmission in which fewer frequency resources are utilized and in which the transmission may span multiple symbol periods. In some designs, each grant-free uplink transmission format corresponds to a particular type (or pattern) of resource allocation while the actual resources utilized for the GF uplink transmission are determined by the UE or in some other way. For example, a first grant-free uplink transmission format (e.g., specifying a resource allocation like 315) may define a resource allocation of multiple resource blocks (RBs) in one or two symbol periods, whereas a second grant-free uplink transmission format (e.g., specifying a resource allocation like 310) may define a resource allocation of a single RB spanning multiple symbol periods. When assigned by the base station 205, the different resource allocations defined by the set of GF uplink transmission formats may also provide flexibility in configuring different UEs 215 so as to reduce overlap between respective UL transmissions.

In general, a narrowband resource allocation over multiple OFDM symbols may provide a power boost in relation to a widerband resource allocation in a single OFDM symbol. Thus, as shown in FIG. 3B, and based on the exemplary channel conditions of FIG. 3A, a grant-free uplink transmission format with a relatively narrowband resource allocation 315 may be utilized with cell-edge UE 215-b and a GF uplink transmission format with a relatively wideband resource allocation 310 may be utilized with cell-center UE 215-a. From the perspective of base station 205, a grant-free uplink transmission format associated with a wideband resource allocation may be assigned when a UE (e.g., UE 215-a) experiences better channel conditions and a grant-free uplink transmission format associated with a narrowband resource allocation may be assigned when the UE (e.g., UE 215-b) experiences worse channel conditions. From the perspective of UE-based format selection, a grant-free uplink transmission format associated with a wideband resource allocation may be (autonomously) selected when UE 215 experiences better channel conditions and a grant-free uplink transmission format associated with a narrowband resource allocation may be selected when it experiences worse channel conditions.

The grant-free uplink transmission format utilized by UEs 215 may also specify a multiplexing level and/or a modulation order for the uplink transmission. The multiplexing level may refer to the extent to which a particular grant-free uplink transmission format is multiplexed with other traffic on the data channel, such as multiplexing with PUSCH transmissions by eMBB users and/or PUSCH transmissions by other URLLC users. To control multiplexing level, base station 205 may define GF resource pools on which eMBB traffic is reduced or avoided. Base station 205 may likewise assign or configure different UEs 215 to use different parts of the GF resource pools so as to achieve a load balancing. In such cases, the grant-free uplink transmission format may specify that GF resources in a particular pool should be utilized for its corresponding resource allocation. From the perspective of base station 205, a grant-free uplink transmission format associated with a higher multiplexing level may be assigned when a UE (e.g., UE 215-a) experiences better channel conditions and a grant-free uplink transmission format associated with a lower multiplexing level may be assigned when the UE (e.g., UE 215-b) experiences worse channel conditions. From the perspective of a UE 215, a grant-free uplink transmission format associated with a higher multiplexing level may be selected when it experiences better channel conditions and a grant-free uplink transmission format associated with a lower multiplexing level may be selected when it experiences worse channel conditions.

Different modulation rates may also be used with different grant-free uplink transmission formats. In general, a grant-free uplink transmission format specifying a lower modulation rate (e.g., BPSK, QPSK) may be utilized in poor channel conditions and a grant-free uplink transmission format specifying a higher modulation rate (e.g., QAM-64, QAM-256) may be utilized in favorable channel conditions. Thus, from the perspective of base station 205, a grant-free uplink transmission format specifying a higher modulation rate may be assigned to a UE that experiences better channel conditions (e.g., UE 215-a) and a grant-free uplink transmission format specifying a lower modulation rate may be assigned to a UE 215 that experiences worse channel conditions (e.g., UE 215-b). From the perspective of a UE 215, a grant-free transmission uplink format having a higher modulation rate may be selected when it experiences better channel conditions and a grant-free uplink transmission format having a lower modulation rate may be selected when it experiences worse channel conditions.

Returning to FIG. 2, in addition to ascertaining the link or channel conditions applicable to communication with UE 215, base station 205 can determine a grant-free uplink transmission format 230 that is best suited for those link conditions. As previously discussed, the selection of a GF format can be influenced by the alignment of the channel conditions with the attributes of the different formats. Thus, base station 205 may consider one or more of the payload size, resource allocation, multiplexing level, and modulation rate specified by the grant-free uplink transmission formats preconfigured for the UE and assign the GF format which represents the best choice.

At 235, the base station 205 assigns the GF format to the UE 215. The assignment can be done semi-statically via radio resource control (RRC) signaling, or dynamically via downlink control information (DCI). In some examples, the assignment is accomplished by sending an indicator or index of the selected GF format which identifies it in the plurality of GF formats that are pre-configured for the UE 215.

UE 215 identifies data for grant-free transmission at 240 and prepares it for uplink transmission. The data may represent a low-latency transmission using the URLLC service or other high-priority transmission which can benefit from reduced latency associated with grant-free transmission. The UE 215 determines its assigned GF format and, at 245, prepares a message in that format for transmission on the uplink. The uplink transmission may be a PUSCH transmission that is multiplexed with PUSCH transmissions of other users. At 250, the UE sends the UL transmission using the assigned grant-free uplink transmission format. In some examples, the UE selects uplink resources according to the resource allocation pattern and/or GF resource pool specified by its assigned GF format and punctures the data channel with its grant-free transmission.

Base station 205 monitors the data channel for GF transmissions at 255 and can detect the transmission of UE 215. In some cases, the base station 205 may perform blind decoding on a set of decoding candidates in order to detect GF transmissions punctured into the data channel. This blind decoding may be aided by a UE-specific DMRS included with the transmission of UE 215. Base station 205 can identify UE 215 based on its DRMS sequence and thereby know its assigned GF format. In this way, it may not be necessary for the base station to test for all possible GF formats in all data channel resources. Instead, base station 205 may be able to limit its monitoring to specific DMRS patterns and GF formats for UEs in accordance with their respective link-based configurations.

FIG. 4 illustrates a further example of a communications flow 400 in a wireless communication system that supports grant-free uplink communication in accordance with various aspects of the present disclosure. In some examples, the wireless communication system may implement aspects of wireless communication system 100.

Communications flow 400 illustrates an interaction between a UE 215 and a base station 205 in support of GF transmission on an uplink data channel. The UE 215 may be an example of aspects of UE 115 as described with reference to FIG. 1. The base station 205 may be an example of aspects of base station 105 as described with reference to FIG. 1.

At 410, UE 215 registers for low latency service with base station 205. This may include sending capabilities information to base station 205 and/or requesting to start URLLC service or to utilize other low-latency, high-priority communications. The UE 215 determines channel conditions at 415 to assess its communication link with base station 205. As previously discussed, determining channel conditions may include taking measurements of one or more serving cells and/or one or more neighbor cells. Neighbor cells may represent potential sources of interference for communication with base station 205. Serving cell measurements may help UE 215 to detect changing RF conditions as it maintains a link with base station 205. Measurements by UE 215 may be supplemented by position location information, HARQ performance, historical operating data, and/or information from base station 205.

When URLLC or other high priority data is identified at 420, UE 215 prepares an uplink transmission. To meet latency requirements associated with URLLC or other services, UE 205 may determine to use a GF transmission instead of first requesting uplink resources from base station 205 and waiting to receive a grant. As discussed previously, UE 215 may have a plurality of pre-defined grant-free uplink transmission formats from which to select. These GF formats may be provisioned in the device and their respective parts may be defined by a standards setting organization such as the 3rd Generation Partnership Project (3GPP). In another example, a set of GF formats may be signaled to UE 215 by base station 205 in one or more upper-layer (e.g., RRC layer) configuration messages. In either case, each GF format in the plurality of preconfigured GF formats may have a corresponding index or identifier.

At 425, UE 215 selects a GF format for the uplink transmission based on previously determined channel conditions. As described in connection with FIGS. 3A-3B, each of the preconfigured, grant-free uplink transmission formats may have different properties or attributes which are suited for communicating in different link conditions. The properties or attributes may include a payload size, a resource allocation, a multiplexing level, and a modulation rate. With knowledge of channel conditions, UE 215 can match a particular GF format to a particular operating environment. As discussed herein, UE 215 may determine that relatively poor channel conditions can support a GF format having a small payload, a narrow-band resource allocation, a low resource multiplexing level, and/or a low order modulation scheme, and may select a GF format which has some or all of these attributes. Similarly, UE 215 may determine that relatively good channel conditions can support a GF format having a large payload, a wideband resource allocation, a higher multiplexing level, and/or a higher order modulation scheme, and may select a GF format which has some or all of these attributes. As channel conditions change, UE 215 may select different ones from among the plurality of preconfigured grant-free uplink transmission formats. At 430, UE 215 generates a data channel message in accordance with the selected GF format.

Having selected a GF format based on channel conditions, and having prepared a message in the selected format for transmission of the data, at 435, UE 215 sends the UL transmission on a data channel. The data channel can be a shared channel such PUSCH in which resources are also allocated through a grant-based mechanism and which is utilized with different users and traffic types. In one example, the UL transmission punctures PUSCH according to the resource allocation of the selected GF format (e.g., narrowband frequency resources, wideband frequency resources, one symbol period, multiple symbol periods, etc.). UE 215 may select the particular UL resources from the full PUSCH bandwidth, or it may select from one or more grant-free resource pools. As previously discussed, in some examples, grant-free resource pools may be configured for UE 215 to facilitate load balancing and/or use of the lower multiplexing levels. A demodulation reference signal (DMRS) may accompany the uplink transmission. The DMRS may facilitate demodulation of the UL transmission by base station 205. In some examples, the DMRS includes a sequence which identifies the UL transmission as being from UE 215. The sequence, for example, may be cyclically shifted base sequence in which the amount of the shift is determined according to a UE identifier.

At 440, base station 205 monitors the data channel for GF transmissions. This monitoring may include a blind decoding of PUSCH in which base station 205 attempts to detect one or more of the pre-configured grant-free uplink transmission formats. To facilitate decoding when base station 205 does not assign the GF format, UE 215 may include a GF format indicator with the UL transmission at 435. The indicator may be an explicit indicator or an implicit indicator. For example, UE 205 may explicitly convey the index or format identifier for its selected format in the UL transmission. Alternatively, UE 215 may implicitly signal the selected GF format such as by its selection of UL resources, by varying the shift of its DMRS sequence, etc. With use of a GF format indicator, base station 215 may not need to perform blind decoding with respect to all possible resource allocation patterns for the plurality of preconfigured GF formats.

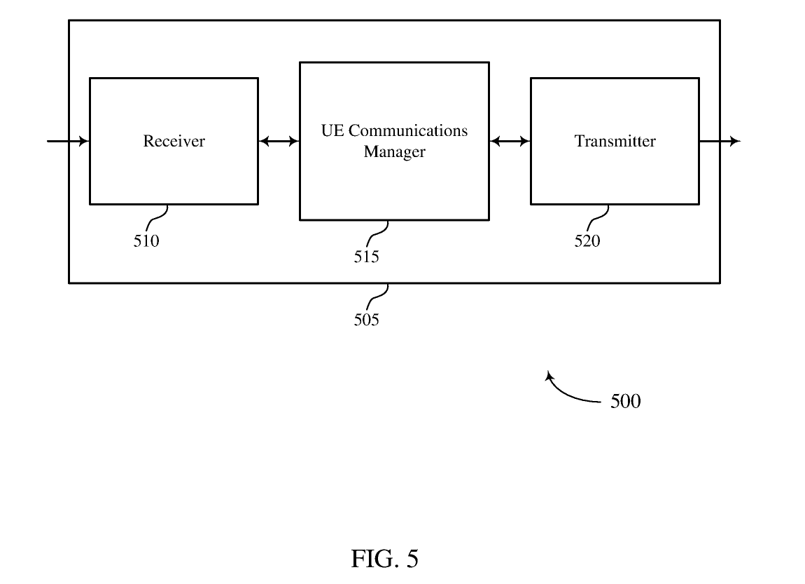

FIG. 5 is a block diagram 500 of a wireless device 505 that supports grant-free uplink communication in accordance with aspects of the present disclosure. Wireless device 505 may be an example of aspects of a user equipment (UE) 115, or a user equipment 215, as described herein. Wireless device 505 may include a receiver 510, a UE communications manager 515, and a transmitter 520. Wireless device 505 may also include a processor. Each of these components may be in communication with one another (e.g., via one or more buses).

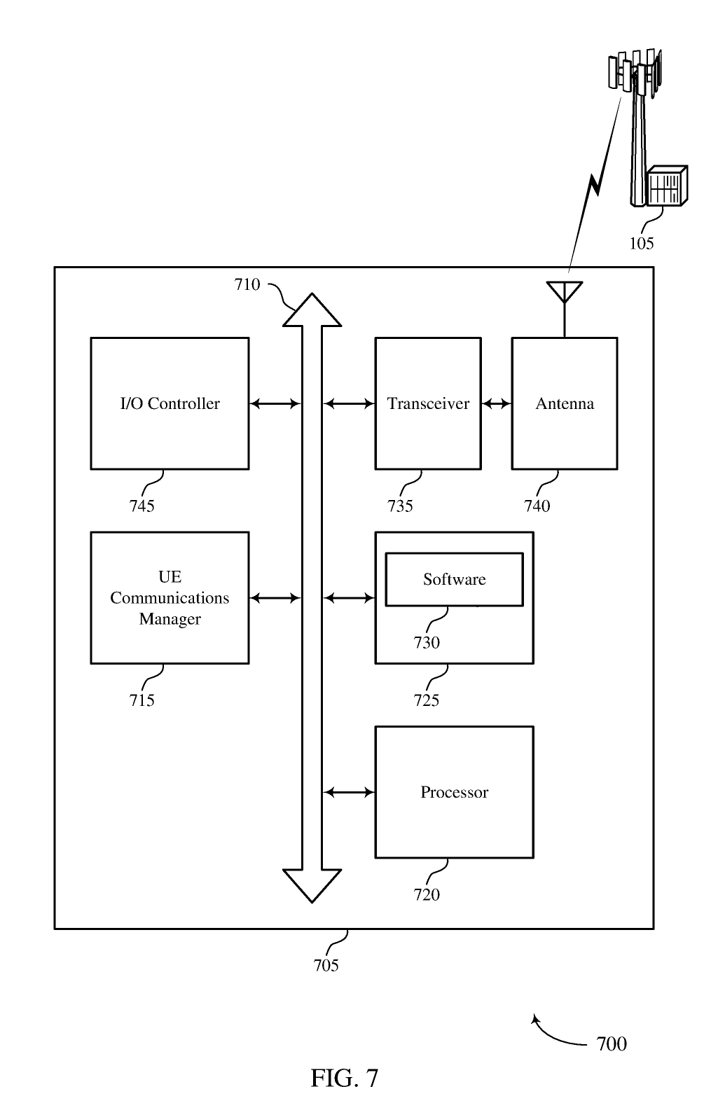

Receiver 510 may receive information such as packets, user data, or control information associated with various information channels (e.g., control channels, data channels, information related to grant-free uplink transmission, etc.) and, under control of a processor or UE communications manager 515, may take serving cell and/or neighbor cell measurements. Information may be passed on to other components of the device. Receiver 510 may utilize a single antenna or a set of antennas and may be an example of aspects of transceiver 735 described with reference to FIG. 7.

UE communications manager 515 and/or at least some of its various sub-components may be implemented in hardware, software executed by a processor, firmware, or any combination thereof. If implemented in software executed by a processor, the functions of the UE communications manager 515 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The UE communications manager 515 and/or at least some of its various sub-components may be physically located at various positions, including being distributed such that portions of functions are implemented at different physical locations by one or more physical devices. In some examples, UE communications manager 515 and/or at least some of its various sub-components may be a separate and distinct component in accordance with various aspects of the present disclosure. In other examples, UE communications manager 515 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

UE communications manager 515 may identify high priority data, such as ULLC communications, for uplink transmission and may select a grant-free transmission format from among a plurality of grant-free transmission formats for sending the data to a base station on an uplink data channel. UE communications manager 515 may also receive an indication of an assigned grant-free transmission format from the base station and may select the grant-free transmission format based on the indication. In some examples, UE communications manager 515 and receiver 510 may operate to determine channel conditions for a link between device 505 and the base station and may select the grant-free transmission format based at least in part on the determined channel conditions.

Transmitter 520 may transmit signals generated by other components of device 505. In some examples, the transmitter 520 may be collocated with receiver 510 in a transceiver module. For example, the transmitter 520 may be an example of aspects of the transceiver 735 described with reference to FIG. 7. The transmitter 520 may utilize a single antenna or a set of antennas. In some aspects, transmitter 520 is coupled to UE communications manager 515 and is configured to send the GF transmission on the uplink data channel.

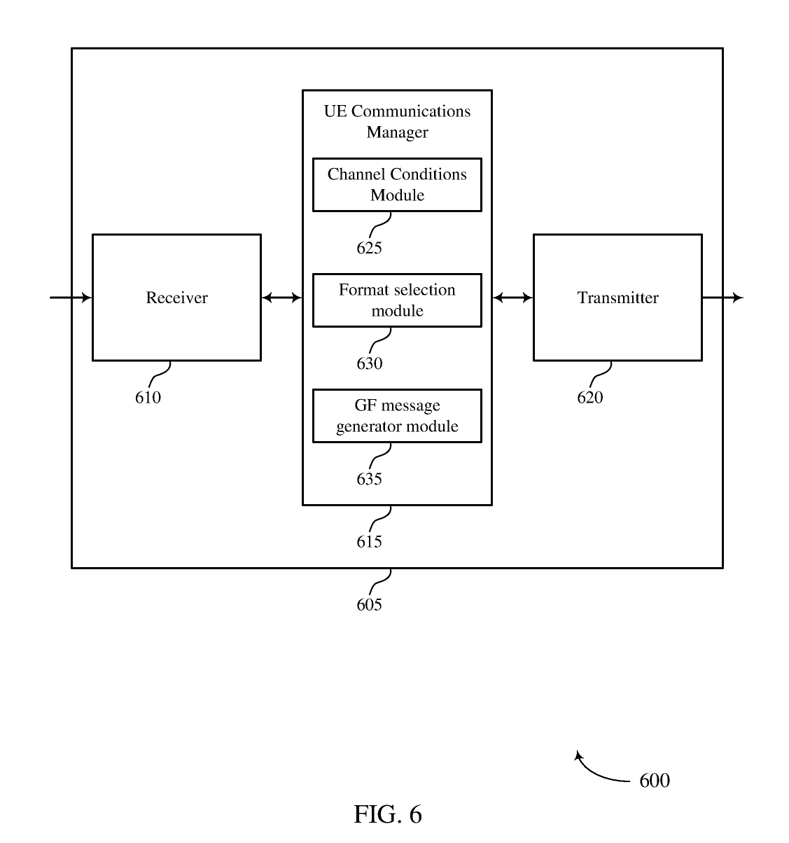

FIG. 6 is a diagram 600 of a wireless device 605 that supports grant-free uplink communication in accordance with aspects of the present disclosure. Wireless device 605 may be an example of UE 115, or UE 215, and may perform functions as described in FIGS. 1-5. As shown, wireless device 605 includes a receiver 610, a UE communications manager 615, and a transmitter 620. UE communications manager 615 may be an example of aspects of a UE communications manager 515, or portions of UE 115 or UE 215 as described with reference to FIGS. 1-5. UE communications manager 615 may include a channel conditions module 625, a format selection module 630, and a GF message generator module 635. Each of these modules may communicate, directly or indirectly, with one another (e.g., via one or more buses).

Channel conditions module 625 may determine channel conditions for a link between device 605 and a base station and may cause device 605 to transmit one or more reports to the base station indicative of the channel conditions. For example, channel conditions module 625 may obtain measurements from receiver 610 and may determine a signal strength associated with one or more serving cells of base station 105 and/or one or more neighbor cells. Measurements of the serving cells, particularly in the context of a TDD system, may provide a good indication of link quality. Measurements of the neighbor cells may indicate a level of interference to UL transmissions by wireless device 605. Channel conditions module 625 may also be configured to form estimates of channel conditions based on HARQ performance, location within a cell, feedback from a serving base station, and other relevant factors. In some examples, wireless device 605 may report channel state information (CSI) obtained by channel conditions module 625 (including a rank indicator (RI)), a channel quality indicator (CQI), a pre-coding matrix indicator (PMI), etc. to a serving base station via transmitter 620.

Format selection module 630 may receive information about channel conditions from channel conditions module 625 and may select a suitable grant-free uplink transmission format from a plurality of pre-defined GF formats as previously discussed. In some examples, format selection module 630 may select a GF format that has been assigned by its base station; in other examples, selection of the GF format may be performed by wireless device 605 as orchestrated by UE communication manager 615. For instance, as discussed with reference to FIG. 2, base station 205 may assign a GF format to device 605 based on one or more channel condition reports, and format selection module 630 may select the assigned GF format when data is identified for a GF uplink transmission. In some examples, the assignment may be semi-static and signaled via radio resource control (RRC) signaling, or it can be dynamic and signaled via downlink control information (DCI). As discussed in FIG. 4, a UE (or wireless device 605) may autonomously select a GF format based on channel conditions.

GF message generator module 635 may form a message for uplink transmission based on the GF format selected by format selection module 630. GF message generator module 635 may receive high-priority data for UL transmission and may form a message having a payload size, resource allocation pattern, multiplexing-level, and modulation rate as defined by the selected GF format. GF message generator module 635 may also provide an identifier of wireless device 605 (e.g., a DMRS pattern) and an indicator of the selected GF format to accompany the uplink transmission.

Transmitter 620 receives the message from message generator module 635 and transmits it on an uplink data channel. The transmission is done in accordance with the selected GF format, the DMRS pattern, and the GF format indicator, if any.

FIG. 7 shows a diagram of a system 700 including a device 705 that supports grant-free uplink communication in accordance with aspects of the present disclosure. Device 705 may be an example of, or include the components of wireless device 505, wireless device 605, UE 115, and/or UE 215 as described above, e.g., with reference to FIGS. 1-6. Device 705 may include components for bi-directional voice and data communications including components for transmitting and receiving communications, including UE communications manager 715, processor 720, memory 725, software 730, transceiver 735, antenna 740, and I/O controller 745. These components may be in electronic communication via one or more buses (e.g., bus 710). Device 705 may communicate wirelessly with one or more base stations 105.

Processor 720 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 720 may be configured to operate a memory array using a memory controller. In other cases, a memory controller may be integrated into processor 720. Processor 720 may be configured to execute computer-readable instructions stored in a memory to perform various functions (e.g., functions or tasks supporting grant-free uplink transmission).

Memory 725 may include random access memory (RAM) and read only memory (ROM). The memory 725 may store computer-readable, computer-executable software 730 including instructions that, when executed, cause the processor to perform various functions described herein. In some cases, the memory 725 may contain, among other things, a basic input/output system (BIOS) which may control basic hardware or software operation such as the interaction with peripheral components or devices.

Software 730 may include code to implement aspects of the present disclosure, including code to support grant-free uplink communication. Software 730 may be stored in a non-transitory computer-readable medium such as system memory or other memory. In some cases, the software 730 may not be directly executable by the processor but may cause a computer (e.g., when compiled and executed) to perform functions described herein.

Transceiver 735 may communicate bi-directionally, via one or more antennas, wired, or wireless links as described above. For example, the transceiver 735 may represent a wireless transceiver and may communicate bi-directionally with another wireless transceiver. The transceiver 735 may also include a modem to modulate the packets and provide the modulated packets to the antennas for transmission, and to demodulate packets from signals received from the antennas.

In some cases, the wireless device may include a single antenna 740. However, in some cases the device may have more than one antenna 740, which may be capable of concurrently transmitting or receiving multiple wireless transmissions.

I/O controller 745 may manage input and output signals for device 705. I/O controller 545 may also manage peripherals not integrated into device 705. In some cases, I/O controller 745 may represent a physical connection or port to an external peripheral. In some cases, I/O controller 745 may utilize an operating system such as iOS®, ANDROID®, MS-DOS®, MS-WINDOWS®, OS/2®, UNIX®, LINUX®, or another known operating system. In other cases, I/O controller 745 may represent or interact with a modem, a keyboard, a mouse, a touchscreen, or a similar device. In some cases, I/O controller 745 may be implemented as part of a processor. In some cases, a user may interact with device 705 via I/O controller 745 or via hardware components controlled by I/O controller 745.

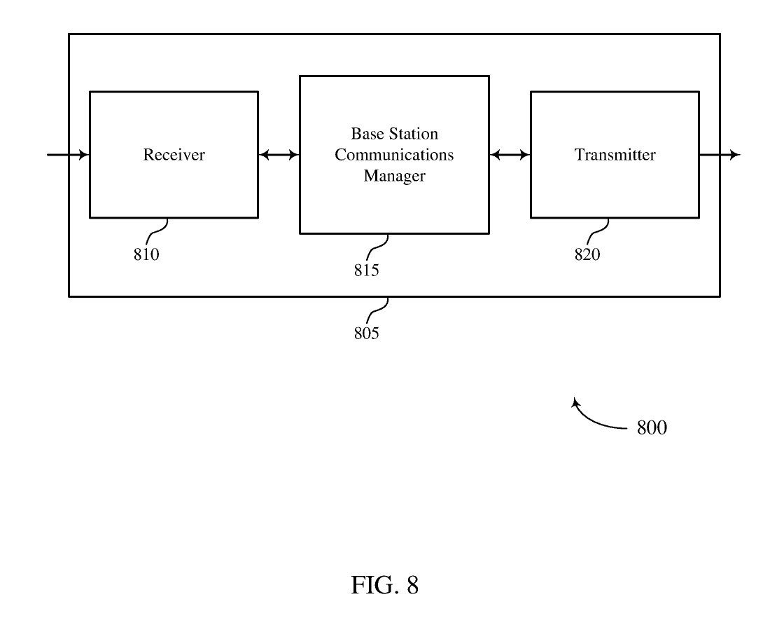

FIG. 8 is a block diagram 800 of a wireless device 805 that supports grant-free uplink communication in accordance with aspects of the present disclosure. Wireless device 805 may be an example of aspects of a base station 105, 205 as described herein. Wireless device 805 may include a receiver 810, a base station communications manager 815, and a transmitter 820. Wireless device 805 may also include a processor. Each of these components may be in communication with one another (e.g., via one or more buses).

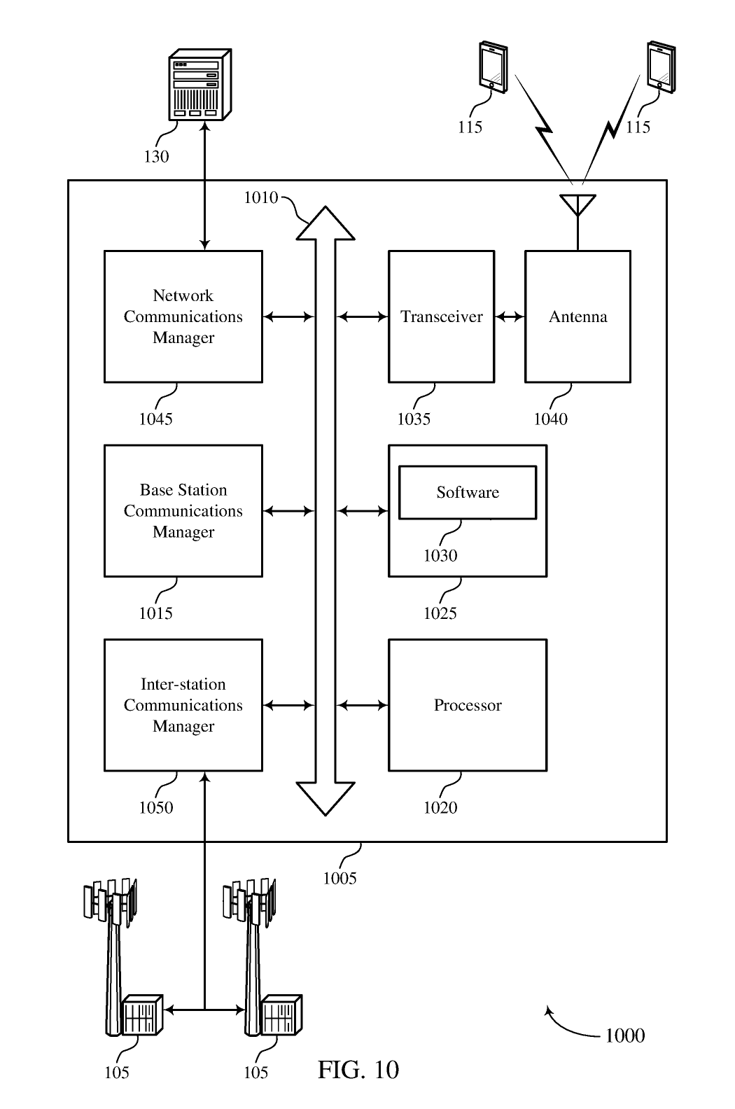

Receiver 810 may receive information such as packets, user data, or control information associated with various information channels (e.g., control channels, data channels, information related to grant-free uplink communication, etc.). Information may be passed on to other components of the device. The receiver 810 may utilize a single antenna or a set of antennas. The receiver 810 may be an example of aspects of transceiver 1035 described with reference to FIG. 10.

Base station communications manager 815 and/or at least some of its various sub-components may be implemented in hardware, software executed by a processor, firmware, or any combination thereof. If implemented in software executed by a processor, the functions of the base station communications manager 815 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure. The base station communications manager 815 and/or at least some of its various sub-components may be physically located at various positions, including being distributed such that portions of functions are implemented at different physical locations by one or more physical devices. In some examples, base station communications manager 815 and/or at least some of its various sub-components may be a separate and distinct component in accordance with various aspects of the present disclosure. In other examples, base station communications manager 815 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure. Base station communications manager 815 may be an example of aspects of the base station communications manager 1015 described with reference to FIG. 10.

In some examples, base station communications manager 815 may determine channel conditions for a link between the base station and a UE and may assign a grant-free transmission format to the UE based on the channel conditions. In other examples, base station communications manager 815 may receive a grant-free uplink data channel transmission from a UE, identify the UE based at least in part on a demodulation reference signal accompanying the transmission, identify a grant-free transmission format associated with the grant-free transmission, and process the transmission based on identifying the UE and the grant-free transmission format.

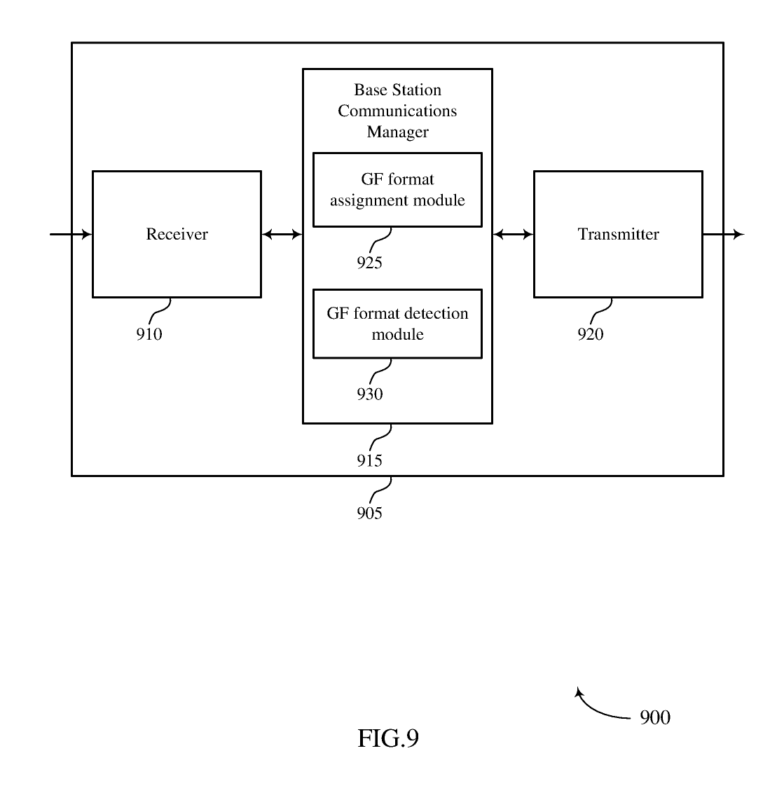

Base communications manager 815 may be an example of aspects of the base station communications manager 915 described with reference to FIG. 9, or of the base station communications manager 1015 described with reference to FIG. 10.

Transmitter 820 may transmit signals generated by other components of the device. In some examples, the transmitter 820 may be collocated with a receiver 810 in a transceiver module. For example, the transmitter 820 may be an example of aspects of transceiver 1035 described with reference to FIG. 10. The transmitter 820 may utilize a single antenna or a set of antennas.

FIG. 9 is a block diagram 900 of a wireless device 905 that supports grant-free uplink communication in accordance with aspects of the present disclosure. Wireless device 905 may be an example of aspects of a base station 105, or base station 205, as described herein. As shown, wireless device 905 includes a receiver 910, a base station communications manager 915, and a transmitter 920. Base station communications manager 915 may include a GF format assignment module 925 and a GF format detection module 930. Each of these elements may communicate, directly or indirectly, with one another (e.g., via one or more buses).

Receiver 910 may receive one or more reports with information that is indicative of channel conditions between a UE and wireless device 905. As described herein, the one or more reports may include channel state information based on UE measurements and/or information about potential interference from neighbor cells. Receiver 910 may also be configured to monitor an uplink data channel for grant-free uplink transmissions as described herein. For example, under the control of base station communications manager 915, receiver 910 may perform blind decoding on an uplink data channel in order to identify GF uplink transmissions from a particular UE and a corresponding GF uplink transmission format.

GF format assignment module 925 may receive information about channel conditions from receiver 910 and may assign a particular GF format to a UE. In some examples, GF format assignment module 925 selects a grant-free uplink transmission format for UEs based on the quality of the link with wireless device 905. For instance, GF format assignment module 925 may assign a grant-free transmission format based on channel conditions such that a larger payload is utilized when channel conditions are relatively good and a smaller payload size when channel conditions are relatively poor as determined from the reports and CSI obtained from UEs. Likewise, GF format assignment module 925 may assign a grant-free transmission format associated with a wideband resource allocation for good channel conditions and a narrowband resource allocation for poor channel conditions. As another example, GF format assignment module 925 may assigned a grant-free transmission format associated with a higher resource multiplexing level for good channel conditions and a lower resource multiplexing level for poor channel conditions, and/or it may assign a grant-free transmission format which specifies a higher order modulation rate for good channel conditions and a lower order modulation rate for poor channel conditions. Any combination of the foregoing is possible. GF format assignment module 925 may utilize one or more link quality thresholds to aid in GF format selection. For example, if channel conditions are poor and fall below a lowest threshold, then a UE may be assigned a GF format with limited or no payload. In an extreme case, the GF format may approximate a scheduling request signal which simply alerts wireless device 905 that the UE has data to send but does not provide a separate payload. As channel conditions improve as determined by, for example, further threshold comparisons, the payload size of the assigned GF format may increase to progressively accommodate a buffer status report and larger amounts of data. Similarly, GF formats with higher modulation rates or wider bandwidths, and larger resource allocation patterns may be utilized with channel conditions improve. When a GF format has been determined, transmitter 920 can send the assignment to the corresponding UE. In some examples, the assignment may be semi-static and conveyed through upper-layer signaling, possibly as part of a device configuration. In other examples, the assignment may be dynamic and included as part of downlink control information.

GF format detection module 930 can detect GF uplink transmissions in a shared data channel. For example, the combination of GF format detection module 930 and receiver 910 can perform blind decoding of the shared data channel with decoding hypotheses which are based on the set of preconfigured GF formats used by one or more UEs. GF format detection module 930 may identify a particular UE based at least in part on a demodulation reference signal accompanying the received transmission and may identify a grant-free transmission format associated with the grant-free transmission. Identifying the grant-free transmission format may include identifying a resource allocation pattern associated with the GF format based on an explicit or implicit indication. As an example, if four preconfigured GF formats are utilized, the grant-free uplink transmission format may include format two format identifier bits. Alternatively, GF format may be implicitly signaled by a shift in the DMRS pattern, the resources on which the UL transmission is detected, or some other means. Base station communications manager 905 can the process the transmission based on identifying the UE and the grant-free transmission format utilized.

FIG. 10 shows a diagram of a system 1000 including a device 1005 that supports grant-free uplink communication in accordance with aspects of the present disclosure. Device 1005 may be an example of (or include the components of) base station 105 or base station 205 as described above, e.g., with reference to FIGS. 1-9. Device 1005 may include components for bi-directional voice and data communications including components for transmitting and receiving communications, including base station communications manager 1015, processor 1020, memory 1025, software 1030, transceiver 1035, antenna 1040, network communications manager 1045, and inter-station communications manager 1050. These components may be in electronic communication via one or more buses (e.g., bus 1010). Device 1005 may communicate wirelessly with one or more UEs 115.

Processor 1020 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1020 may be configured to operate a memory array using a memory controller. In other cases, a memory controller may be integrated into processor 1020. Processor 1020 may be configured to execute computer-readable instructions stored in a memory to perform various functions (e.g., functions or tasks supporting grant-free uplink communication).

Memory 1025 may include RAM and ROM. The memory 1025 may store computer-readable, computer-executable software 1030 including instructions that, when executed, cause the processor to perform various functions described herein. In some cases, the memory 1025 may contain, among other things, a BIOS which may control basic hardware or software operation such as the interaction with peripheral components or devices.

Software 1030 may include code to implement aspects of the present disclosure, including code to support grant-free uplink communication. Software 1030 may be stored in a non-transitory computer-readable medium such as system memory or other memory. In some cases, the software 1030 may not be directly executable by the processor but may cause a computer (e.g., when compiled and executed) to perform functions described herein.

Transceiver 1035 may communicate bi-directionally, via one or more antennas, wired, or wireless links as described above. For example, the transceiver 1035 may represent a wireless transceiver and may communicate bi-directionally with another wireless transceiver. The transceiver 1035 may also include a modem to modulate the packets and provide the modulated packets to the antennas for transmission, and to demodulate packets from signals received from the antennas.

In some cases, device 1005 may include a single antenna 1040. However, in some cases the device may have more than one antenna 1040, which may be capable of concurrently transmitting or receiving multiple wireless transmissions.

Network communications manager 1045 may manage communications with the core network (e.g., via one or more wired backhaul links). For example, the network communications manager 1045 may manage the transfer of data communications for client devices, such as one or more UEs 115.

Inter-station communications manager 1050 may manage communications with other base station(s) 105, and may include a controller or scheduler for controlling communications with UEs 115 in cooperation with other base stations 105. For example, the inter-station communications manager 1050 may coordinate scheduling for transmissions to UEs 115 for various interference mitigation techniques such as beamforming or joint transmission. In some examples, inter-station communications manager 1050 may provide an X2 interface within an Long Term Evolution (LTE)/LTE-A wireless communication network technology to provide communication between base stations 105.

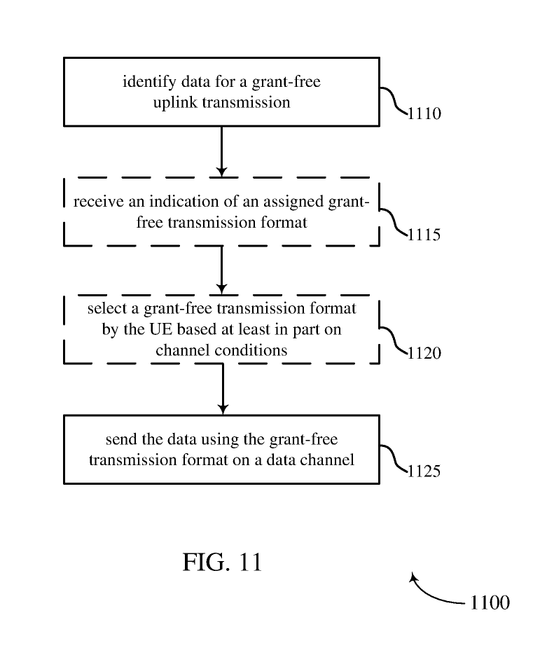

FIG. 11 illustrates a method 1100 for grant-free uplink communication in accordance with aspects of the present disclosure. The operations of method 1100 may be implemented by UE 115, or UE 215, or UE components as described herein. For example, the operations of method 1100 may be performed by a UE communications manager as described with reference to FIGS. 5 through 7. In some examples, a UE 115/215 may execute a set of codes to control the functional elements of the device to perform the functions described below. Additionally or alternatively, the UE 115/215 may perform aspects of the functions described below using special-purpose hardware.

At block 1110, the UE may identify data for a grant-free uplink transmission. For example, the UE may have URLLC or other high-priority data to send and require low latency access to the uplink data channel. In some examples, the UE may first report a URLLC capability to a serving base station and/or may request URLLC service. The operations of block 1110 may be performed according to the methods described herein. For example, aspects of the operations of block 1110 may be performed by a UE communications manager as described with reference to FIGS. 5 through 7.

At block 1115, in a first option, the UE receives an indication of an assigned grant-free transmission format from a serving base station and selects its assigned GF format for use. In a second option, as shown at block 1120, the UE may autonomously select a grant-free transmission format based at least in part on channel conditions. For example, the UE may select a GF format from a plurality of preconfigured GF formats according to current channel conditions. The operations of blocks 1115-1120 may be performed according to the methods described herein. In certain examples, the operations of blocks 1115-1120 may be performed by a receiver and a UE communications manager as described with reference to FIGS. 5 through 7.

At block 1125, the UE may send the identified data using the selected/assigned grant-free transmission format on an uplink data channel. As previously discussed, the UE may also send a DMRS signal for identifying the UE and, optionally, a GF format indicator to identify the selected GF format and to aid the base station in decoding its transmission. The operations of block 1125 may be performed according to the methods described herein. For example, aspects of the operations of block 1125 may be performed by a transmitter as described with reference to FIGS. 5 through 7.

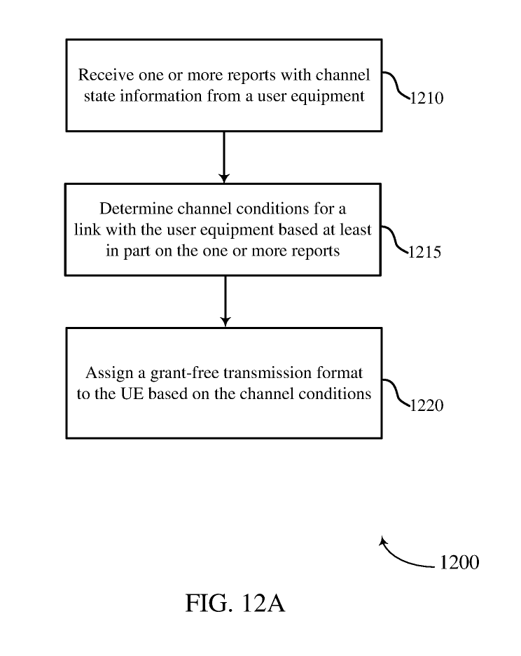

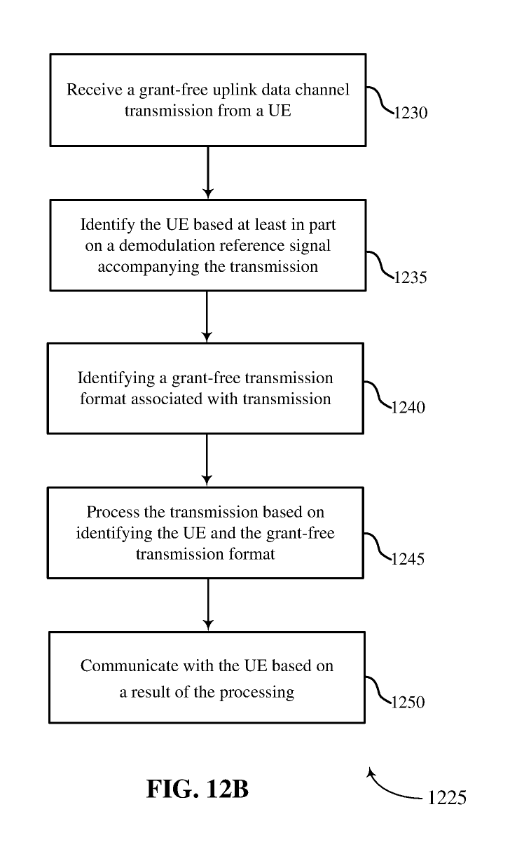

FIG. 12A illustrates a method 1200 for grant-free uplink communication in accordance with aspects of the present disclosure. The operations of method 1200 may be implemented by base station 105, or base station 205, or base station components as described herein. For example, the operations of method 1200 may be performed by a base station communications manager as described with reference to FIGS. 8 through 10 and with reference to the exemplary call flow of FIG. 2. In some examples, a base station 105/205 may execute a set of codes to control the functional elements of the device to perform the functions described below. Additionally or alternatively, the base station 105/205 may perform aspects of the functions described below using special-purpose hardware.

At block 1210, the base station may receive one or more reports with channel state information from a user equipment. The one or more reports may include signal strength measurements (or information derived therefrom) for cells of the base station and/or neighbor cells. Examples may include SINR (signal-to-interference-plus-noise ratio), C/I (carrier-to-interference ratio), RSRP (reference signal received power), RSRQ (reference signal received quality), and the like. The operations of block 1210 may be performed according to the methods described herein. In certain examples, the operations of block 1210 may be performed by a receiver as described with reference to FIGS. 8 through 10.

At block 1215, the base station may determine channel conditions for a link with the user equipment based at least in part on the received reports. In some cases, the UE may also report its current or projected location as an additional factor for use by the base station in determining channel conditions. In other cases, the base station may determine the UE's location and other factors such as historical HARQ performance as part of determining channel conditions for the link. The operations of block 1215 may be performed according to the methods described herein. In certain examples, the operations of block 1215 may be performed by a base station communications manager as described with reference to FIGS. 8 through 10.

At block 1220, the base station may assign a grant-free transmission format to the UE based on the channel conditions. As previously discussed, the base station may compare channel conditions, as reported by the UE, and as further determined by the base station, to a plurality of preconfigured GF formats in order to identify the most suitable GF format. Multiple selection criteria may be utilized such as by identifying a matching format based on one or more of a payload size, a resource allocation pattern, a multiplexing level, and/or a modulation order in the available GF formats. Thereafter, the base station may send an identifier of the assigned GF format to the UE in a downlink message. The assignment can be semi-static or dynamic and can be conveyed in respective upper-layer or control channel messages. The operations of block 1220 may be performed according to the methods described herein. In certain examples, the operations of block 1210 may be performed by a base station communications manager and a transmitter as described with reference to FIGS. 8 through 10.

FIG. 12B illustrates a method 1225 for grant-free uplink communication in accordance with aspects of the present disclosure. The operations of method 1225 may be implemented by a base station 105, or a base station 205, or by base station components as described herein. For example, the operations of method 1225 may be performed by a base station communications manager as described with reference to FIGS. 8 through 10 and with reference to the exemplary call flow of FIG. 4. In some examples, a base station 105/205 may execute a set of codes to control the functional elements of the device to perform the functions described below. Additionally or alternatively, the base station 105/205 may perform aspects of the functions described below using special-purpose hardware.

At block 1230, the base station may receive a grant-free uplink data channel transmission. In some examples, the uplink data channel may be a physical uplink shared channel (PUSCH) and the base station may identify a set of decoding candidates and perform blind detection on the PUSCH. In some examples, at block 1235, the base station may identify the UE that sent a grant-free uplink transmission by a DRMS. For example, the UE identity may be conveyed using a particular DMRS base sequence and/or cyclic shift thereof. The operations of block 1230 may be performed according to the methods described herein. In certain examples, the operations of block 1230 may be performed by a receiver and a base station communication manager as described with reference to FIGS. 8 through 10.

At block 1240, the base station may identify a grant-free transmission format associated with the data channel transmission. In some examples, the UE may include a GF format indicator with its transmission. The GF format indicator may be signaled explicitly (e.g., using bits in the uplink message), or it may be signaled implicitly (e.g., by varying the DMRS sequence, the choice of UL resources, etc). Using the GF format indicator can simplify blind decoding by the base station. The operations of block 1240 may be performed according to the methods described herein. In certain examples, the operations of block 1240 may be performed by a receiver, a base station communication manager, and processor as described with reference to FIGS. 8 through 10. Once the UL transmission has been detected and the UE has been identified, at block 1245, the base station can continue processing the UL data according to the GF format. At block 1245, the base station can communicate with the UE based on a result of the processing. For example, the base station may send an acknowledgement to the UE when the grant free transmission is successfully received an processed. In certain examples, the operations of blocks 1245-1250 may be performed by a receiver, a transmitter, a base station communication manager, and/or a processor as described with reference to FIGS. 8 through 10.

It should be noted that the methods described above describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1x, 1x, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE and LTE-A are releases of UMTS that use E-UTRA. UTRA, E-UTRA, UMTS, LTE, LTE-A, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects of an LTE or an NR system may be described for purposes of example, and LTE or NR terminology may be used in much of the description, the techniques described herein are applicable beyond LTE or NR applications.

A macro cell generally covers a relatively large geographic area (e.g., several kilometers in radius) and may allow unrestricted access by UEs 115 with service subscriptions with the network provider. A small cell may be associated with a lower-powered base station 105, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs 115 with service subscriptions with the network provider. A femto cell may also cover a small geographic area (e.g., a home) and may provide restricted access by UEs 115 having an association with the femto cell (e.g., UEs 115 in a closed subscriber group (CSG), UEs 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications system 100 or systems described herein may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method of wireless communication by a user equipment (UE), comprising:
identifying data for a grant-free uplink transmission;
selecting a grant-free transmission format from among a plurality of grant-free transmission formats;
sending the data to a base station on a data channel using the selected grant-free transmission format.

2. The method of claim 1, further comprising:
determining channel conditions for a link between the UE and the base station; and
selecting the grant-free transmission format, by the UE, based at least in part on the channel conditions.

3. The method of claim 2, wherein sending the data further comprises sending a format indicator corresponding to the selected grant-free transmission format.

4. The method of claim 3, wherein the format indicator comprises an explicit indication of the selected grant-free transmission format or an implicit indication of the selected grant-free transmission format.

5. The method of claim 1, further comprising:
receiving an indication of an assigned grant-free transmission format from the base station; and
selecting the grant-free transmission format based on the indication.

6. The method of claim 5, further comprising:
determining channel conditions for a link between the UE and the base station; and
transmitting one or more reports to the base station indicative of the channel conditions, wherein the indication of the assigned grant-free transmission format is based at least in part on the one or more reports.

7. The method of claim 5, wherein receiving the indication of the assigned grant-free transmission format comprises receiving the indication semi-statically via radio resource control (RRC) signaling, or receiving the indication dynamically via downlink control information (DCI).

8. The method of claim 2 or 6, wherein the determining the channel conditions comprises measuring a signal strength of a serving cell, or measuring a signal strength of a neighbor cell.

9. The method of claim 1, wherein the grant-free transmission format defines a payload size for uplink transmission, a resource allocation for uplink transmission, a multiplexing level for uplink transmission, a modulation rate for uplink transmission, or a combination thereof.

10. The method of claim 1, wherein sending the data comprises sending a demodulation reference signal associated with the UE.

11. The method of claim 1, further comprising:
determining whether the UE is configured for ultra-reliable low latency communications (URLLC), and wherein the grant-free transmission format is selected based further on determining that the UE is configured for URLLC.

12. A method for wireless communications by a base station, comprising:
determining channel conditions for a link between the base station and a user equipment (UE); and
assigning a grant-free transmission format to the UE based on the channel conditions.

13. The method of claim 12, wherein the grant-free transmission format is one of a plurality of grant-free transmission formats pre-configured for the UE.

14. The method of claim 12, wherein assigning the grant-free transmission format to the UE comprises:
assigning the grant-free transmission format semi-statically via radio resource control signaling; or
assigning the grant-free transmission format dynamically via downlink control information.

15. The method of claim 12, wherein assigning the grant-free transmission format to the UE comprises:
determining at least one threshold associated with the link between the base station and the user equipment;
assigning a grant-free transmission format having a larger payload size when the channel conditions exceed the at least one threshold and a smaller payload size when the channel conditions do not exceed the at least one threshold,
assigning a grant-free transmission format associated with a wideband resource allocation when the channel conditions exceed the at least one threshold and a narrowband resource allocation when the channel conditions do not exceed the at least one threshold,
assigning a grant-free transmission format associated with a higher resource multiplexing level when the channel conditions exceed the at least one threshold and a lower resource multiplexing level when the channel conditions do not exceed the at least one threshold, or
assigning a grant-free transmission format specifying a higher order modulation rate when the channel conditions exceed the at least one threshold and a lower order modulation rate when the channel conditions do not exceed the at least one threshold, or
any combination thereof.

16. The method of claim 12, wherein determining the channel conditions is based on one or more reports from the UE, a distance of the UE from the base station, a historical hybrid automatic repeat request (HARQ) performance of the UE, or any combination thereof.

17. The method of claim 12, further comprising determining whether the UE is configured for ultra-reliable low latency communications (URLLC), wherein assigning the grant-free transmission format is further based on determining that the UE is configured for URLLC.

18. A method for wireless communications by a base station, comprising:
receiving a grant-free uplink data channel transmission from a user equipment;
identifying the user equipment based at least in part on a demodulation reference signal accompanying the grant-free uplink data channel transmission;
identifying a grant-free transmission format associated with the grant-free uplink data channel transmission;
processing the grant-free uplink data channel transmission based on identifying the user equipment and identifying the grant-free transmission format; and
communicating with the user equipment based on a result of the processing.

19. The method of claim 18, wherein identifying the grant-free transmission format is based on a format indicator.

20. The method of claim 19, wherein the format indicator comprises an explicit format indicator or an implicit format indicator.

21. The method of claim 18, wherein the grant-free transmission format corresponds to a payload size, a resource allocation, a multiplexing level, a modulation rate, or any combination thereof, for the grant-free uplink data channel transmission.

22. The method of claim 18, wherein the grant-free transmission format is one of a plurality of grant-free transmission formats preconfigured for the UE.

23. The method of claim 18, wherein identifying the UE comprises performing blind decoding by the base station on a set of uplink resources.

24. An apparatus for wireless communication, comprising:
a memory; and
at least one processor coupled to the memory and configured to:
identify data for a grant-free uplink transmission,
select a grant-free transmission format from among a plurality of grant-free transmission formats, and
send the data to a base station on a data channel using the selected grant-free transmission format.

25. The apparatus of claim 24, wherein the at least one processor is further configured to:
determine channel conditions for a link between the apparatus and the base station; and
select the grant-free transmission format, by the apparatus, based at least in part on the channel conditions.

26. The apparatus of claim 24, wherein the at least one processor is further configured to:
receive an indication of an assigned grant-free transmission format from the base station; and
select the grant-free transmission format based on the indication.

27. An apparatus for wireless communication, comprising:
means for identifying data for a grant-free uplink transmission;
means for selecting a grant-free transmission format from among a plurality of grant-free transmission formats; and
means for sending the data to a base station on a data channel using the selected grant-free transmission format.

28. The apparatus of claim 27, further comprising:
means for receiving an indication of an assigned grant-free transmission format from the base station,
wherein the means for selecting are configured to select the grant-free transmission format based on the indication.

29. The apparatus of claim 27, further comprising:
means for determining channel conditions for a link between the apparatus and the base station, and
wherein the means for selecting is configured to select the grant-free transmission format based at least in part on the channel conditions.

30. A non-transitory computer readable medium storing code for wireless communication, the code comprising instructions executable by a processor to:
identify data for a grant-free uplink transmission,
select a grant-free transmission format from among a plurality of grant-free transmission formats, and
send the data to a base station on a data channel using the selected grant-free transmission format.

31. An apparatus for wireless communication, comprising:
a memory; and
at least one processor coupled to the memory and configured to:
determine channel conditions for a link between the apparatus and a user equipment (UE); and
assign a grant-free transmission format to the UE based on the channel conditions.

32. The apparatus of claim 31, wherein the at least one processor is further configured to:
assign the grant-free transmission format semi-statically via radio resource control signaling, or
assign the grant-free transmission format dynamically via downlink control information.

33. The apparatus of claim 31, wherein the at least one processor is further configured to determine the channel conditions based on one or more reports from the UE, a distance of the UE from the apparatus, a historical hybrid automatic repeat request (HARQ) performance of the UE, or any combination thereof.

34. An apparatus for wireless communication, comprising:
means for determining channel conditions for a link between the apparatus and a user equipment (UE); and
means for assigning a grant-free transmission format to the UE based on the channel conditions.

35. The apparatus of claim 34, wherein the means for assigning the grant-free transmission format is configured to assign the grant-free transmission format semi-statically via radio resource control signaling or dynamically via downlink control information.

36. The apparatus of claim 34, wherein the means for determining channel conditions is configured to determine the channel conditions based on one or more reports from the UE, a distance of the UE from the apparatus, a historical hybrid automatic repeat request (HARQ) performance of the UE, or any combination thereof.

37. A non-transitory computer readable medium storing code for wireless communication, the code comprising instructions executable by a processor to:
determine channel conditions for a link with a user equipment (UE); and
assign a grant-free transmission format to the UE based on the channel conditions.

38. An apparatus for wireless communication, comprising:
a memory; and
at least one processor coupled to the memory and configured to:
receive a grant-free uplink data channel transmission from a user equipment (UE);
identify the UE based at least in part on a demodulation reference signal accompanying the grant-free uplink data channel transmission;
identify a grant-free transmission format associated with the grant-free uplink data channel transmission;
process the grant-free uplink data channel transmission based on identifying the UE and the grant-free transmission format; and
communicate with the UE based on a result of the processing.

39. The apparatus of claim 38, wherein the at least one processor is further configured to identify the grant-free transmission format based on a format indicator.

40. The apparatus of claim 39, wherein the format indicator comprises an explicit format indicator or an implicit format indicator.

41. An apparatus for wireless communication, comprising:
means for receiving a grant-free uplink data channel transmission from a user equipment (UE);
means for identifying the UE based at least in part on a demodulation reference signal accompanying the grant-free uplink data channel transmission;
mean for identifying a grant-free transmission format associated with the grant-free uplink data channel transmission;
means for processing the grant-free uplink data channel transmission based on identifying the UE and the grant-free transmission format; and
means for communicating with the UE based on a result of the processing.

42. The apparatus of claim 41, wherein the means for identifying the grant-free transmission format is configured to identify the grant-free transmission format based on a format indicator.

43. The apparatus of claim 42, wherein the format indicator comprises an explicit format indicator or an implicit format indicator.

44. A non-transitory computer readable medium storing code for wireless communication, the code comprising instructions executable by a processor to:
receive a grant-free uplink data channel transmission from a user equipment (UE);
identify the UE based at least in part on a demodulation reference signal accompanying the grant-free uplink data channel transmission;
identify a grant-free transmission format associated with the grant-free uplink data channel transmission;
process the grant-free uplink data channel transmission based on identifying the UE and the grant-free transmission format; and
communicate with the UE based on a result of the processing.
